(19) United States
(12) Patent Application Publication
(10) Pub. No.: US 2012/0241341 A1
(43) Pub. Date: Sep. 27, 2012

(54) SHOCK-ABSORBING GOLF BAG AND STRAP SYSTEM

(75) Inventors: James R. HARRIS, Anaheim, CA (US); Adam K. SHELDON, Long Beach, CA (US)

(73) Assignee: SRI SPORTS LIMITED, KOBE-SHI (JP)

(21) Appl. No.: 13/069,927

(22) Filed: Mar. 23, 2011

(51) Int. Cl. A63B 55/00; A45F 3/12; B32B 3/06; A45F 3/14

(52) U.S. Cl. 206/315.3; 224/201; 428/101; 428/54

(57) ABSTRACT

A shock-absorbing strap assembly for attachment to a load including an inelastic strap having an elongate direction and a widthwise direction and a discrete elastic member having an expandable portion. The elastic member is coupled to the inelastic strap. The inelastic strap is coupled to, and overlaps, the elastic member such that, when the strap assembly is in a relaxed state, the inelastic strap forms at least one slack. The strap assembly further includes a shoulder pad coupled to the inelastic strap and at least partially overlapping the inelastic strap and the elastic member, such that at least a portion of the inelastic strap slidably engages with at least a portion of the shoulder pad when an external tension is applied to the inelastic strap.

### COPYRIGHT AUTHORIZATION

The disclosure below may be subject to copyright protection. The copyright owner has no objection to the facsimile reproduction by anyone of the documents containing this disclosure, as they appear in the Patent and Trademark Office records, but otherwise reserves all applicable copyrights.

### FIELD OF THE INVENTION

This invention relates to load-carrying bags and more particularly load-carrying bags for transporting golf clubs and related golf equipment.

### BACKGROUND

During a golf round, players may carry their golf equipment over long distances. To alleviate the physical strain associated with carrying one's golf equipment, players generally utilize golf bags having a pair of shoulder straps to distribute the weight of their golf bag between both shoulders. However, given the typical weight of the average player's golf bag, the shoulder straps may not provide sufficient support to the player, which, in some instances, may lead to a serious injury.

Although golf bag manufacturers have introduced different types of shoulder strap assemblies in an attempt to increase the comfort of carrying such weight, limited benefits have been achieved. For example, golf bag manufacturers have introduced shoulder strap devices that include elastic elements. However, merely incorporating an elastic component, or similar spring device, into the shoulder strap of a golf bag does not sufficiently stabilize the golf bag as the player traverses a golf course. Moreover, conventional strap assemblies having shock-absorption means tend not to optimize important properties, e.g., degree of stiffness, maximum elongation, and/or degree of damping, in consideration of the typical loads acting on a golfer's shoulders as the golfer traverses a golf course. Even further, conventional strap systems that include elastics or other spring-like members are generally constructed in a manner that significantly increases production costs.

### SUMMARY

A need exists for a golf bag shoulder strap assembly that minimizes discomfort due to the typical loading applied to the strap assembly and may be manufactured in a cost-effective manner.

A shock-absorbing strap assembly according to an example of the invention may include an inelastic strap having an elongate direction and a widthwise direction, a discrete elastic member having an expandable portion, the elastic member coupled to the inelastic strap, wherein the inelastic strap is coupled to, and overlaps, the elastic member such that, when the strap assembly is in a relaxed state, the inelastic strap forms at least one slack, and a shoulder pad coupled to the inelastic strap and at least partially overlapping the inelastic strap and the elastic member, such that at least a portion of the inelastic strap slidably engages with at least a portion of the shoulder pad when an external tension is applied to the inelastic strap.

In another example of the present invention, a shock-absorbing strap assembly for attachment to a load may include a first sub-assembly having a first inelastic strap having a first elongate direction and a first widthwise direction, a first discrete elastic member having a first expandable portion, the first elastic member coupled to the first inelastic strap. The first inelastic strap is coupled to, and overlaps, the first elastic member such that, when the strap assembly is in a relaxed state, the first inelastic strap forms one or more first slacks. The strap assembly further includes a first shoulder pad coupled to the first inelastic strap and at least partially overlapping the first inelastic strap and the first elastic member, such that at least a portion of the first inelastic strap slidably engages with at least a portion of the first shoulder pad when an external tension is applied to the first inelastic strap, and a second sub-assembly including a second inelastic strap having a second elongate direction and a second widthwise direction, a second discrete elastic member having a second expandable portion, the second elastic member coupled to the second inelastic strap. The second inelastic strap is coupled to, and overlaps, the second elastic member such that, when the strap assembly is in a relaxed state, the second inelastic strap forms one or more second slacks. The strap assembly further includes a second shoulder pad coupled to the second inelastic strap and at least partially overlapping the second inelastic strap and the second elastic member, such that at least a portion of the second inelastic strap slidably engages with at least a portion of the second shoulder pad when an external tension is applied to the second inelastic strap.

In another example of the present invention, a strap assembly may include a first discrete sub-assembly and a second discrete sub-assembly, each of the first and second sub-assemblies having an inelastic strap having a first, a second end, an intermediate portion located between, and spaced from each of, the first end and the second end, and extending in an elongate direction, an elastic member coupled to the intermediate portion of the inelastic member and extending in the elongate direction of the inelastic strap, and a first resilient member and a second resilient member. The intermediate portion of the inelastic strap and the elastic member are sandwiched between, and in slidable contact with, the first resilient member and the second resilient member.

In another example of the present invention, a strap assembly may include an inelastic strap member having a width, a thickness, a first end, a second end opposite the first end, an intermediate portion between, and spaced from each of, the first end and the second end, and an imaginary center line located midway between the width and the thickness, the inelastic strap extending in an elongate direction, an elastic member coupled to the intermediate portion of the inelastic strap, the elastic member having an expandable portion including a first end and a second end rearward of the first end, in the elongate direction, a shoulder pad comprising a resilient material, a forward end, and a rearward end, the shoulder pad overlapping, and in slidable contact with, at least the intermediate portion of inelastic strap. When the strap assembly is laid out in a horizontal plane such that the center line of the support strap is generally parallel to the horizontal plane, a nexus of points defining the outer most boundary of the shoulder pad, as viewed in a direction normal to the horizontal plane, projected on the horizontal plane, forms a projected perimetric boundary of the shoulder pad, the perimetric boundary intersects the center line at a forward end and at a rearward end opposite the forward end, a first length extends between the forwardmost end of the expandable portion of the elastic member, projected in the horizontal plane, and the rearward end of the perimetric boundary of the shoulder pad, and a second length extends between the forward end and the rearward end of the perimetric boundary of the shoulder pad such that a ratio of the first length to the second length is between about 0.25 and about 0.50.

The various exemplary aspects described above may be implemented individually or in various combinations. These and other features and advantages of shock-absorbing strap assemblies according to the invention in its various aspects and demonstrated by one or more of the various examples will become apparent after consideration of the ensuing description, the accompanying drawings, and the appended claims.

### BRIEF DESCRIPTION

The drawings described below are for illustrative purposes only and are not intended to limit the scope of the present invention in any way. Exemplary implementations will now be described with reference to the accompanying drawings, wherein:

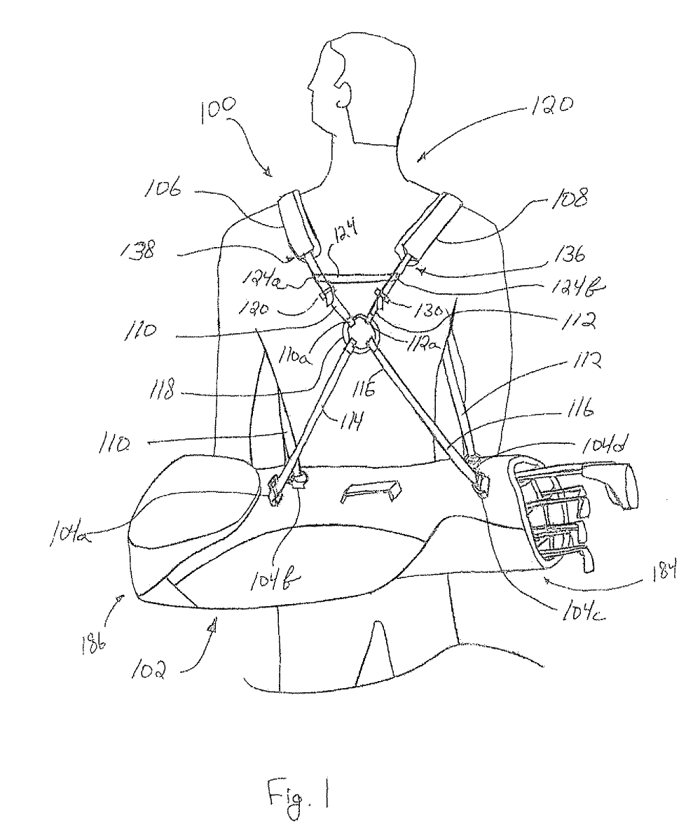

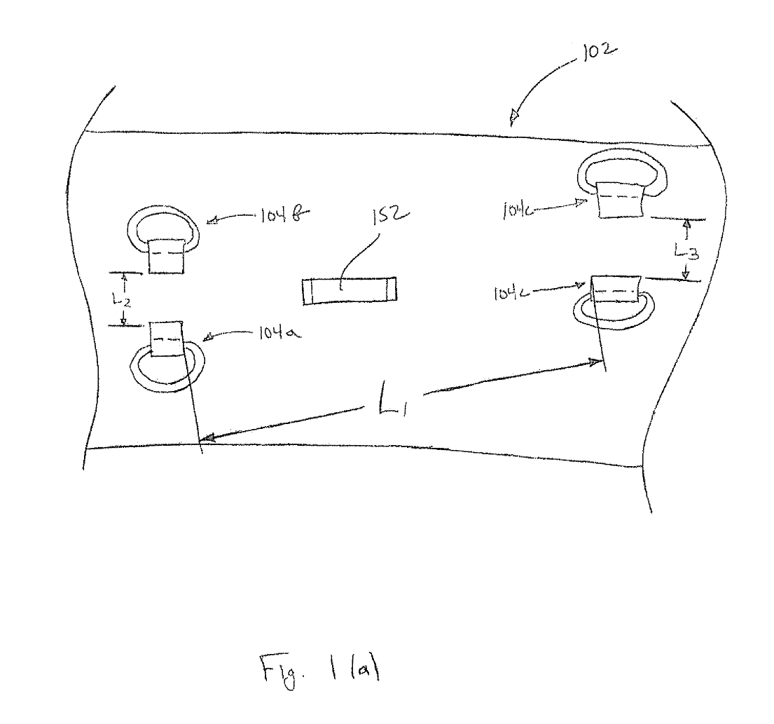

FIG. 1 is a rear perspective view of an exemplary golf bag and strap system in accordance with one or more aspects of the present invention.

FIG. 1(a) is a top view of a portion of the golf bag of FIG. 1.

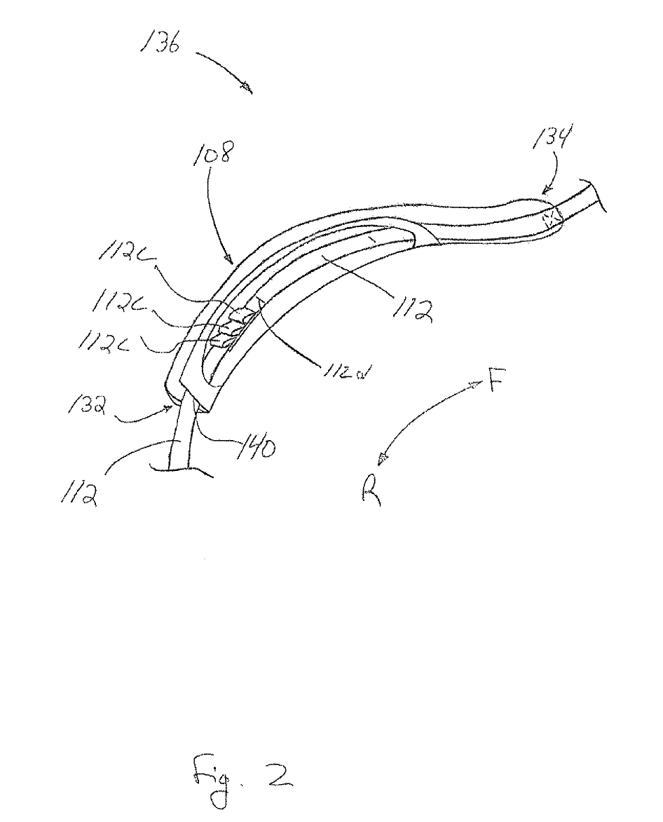

FIG. 2 is a cut-away view of a portion of the strap system of FIG. 1.

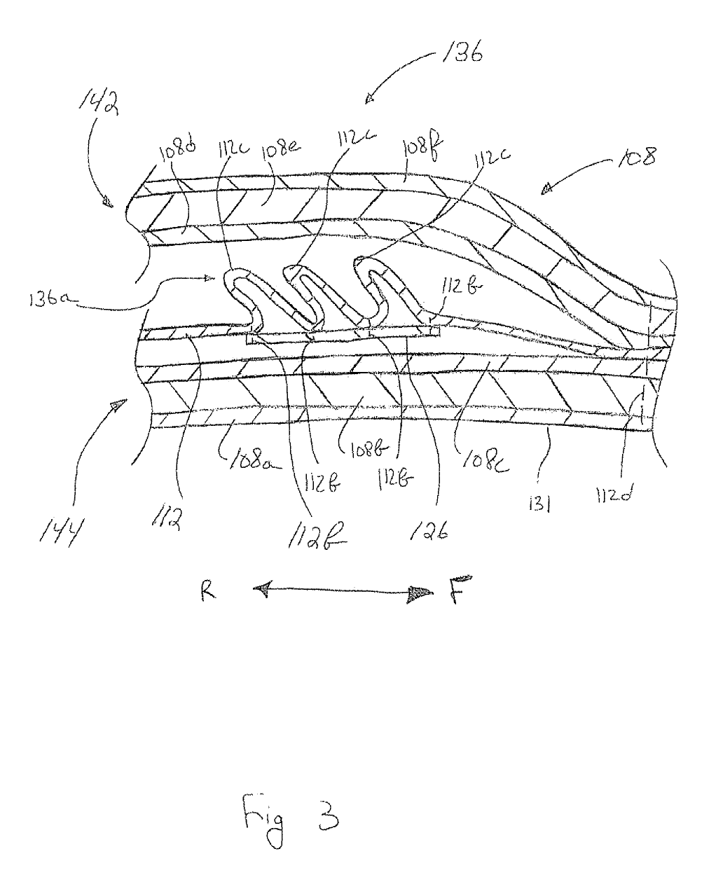

FIG. 3 is a cross-sectional view of a portion of the strap system of FIG. 1.

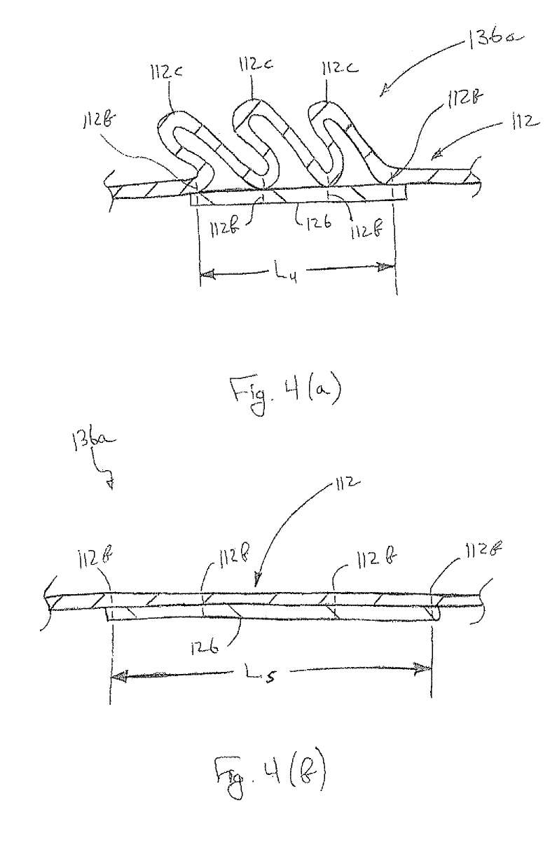

FIG. 4(a) is a cross-sectional view of a portion of the strap system of FIG. 1 in a relaxed state.

FIG. 4(b) is a cross-sectional view of a portion of the strap system of FIG. 1, in a fully-expanded state.

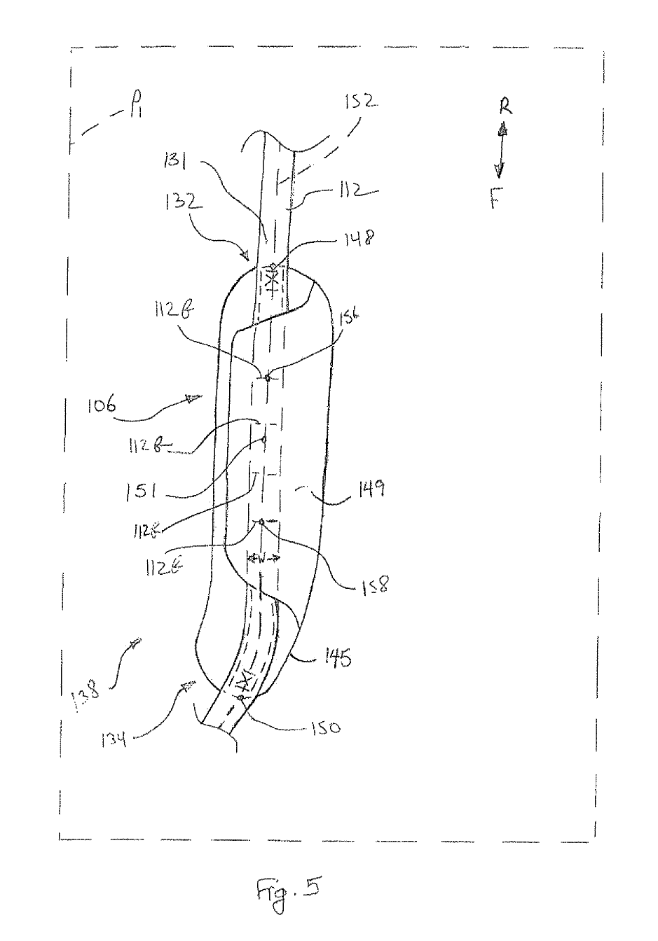

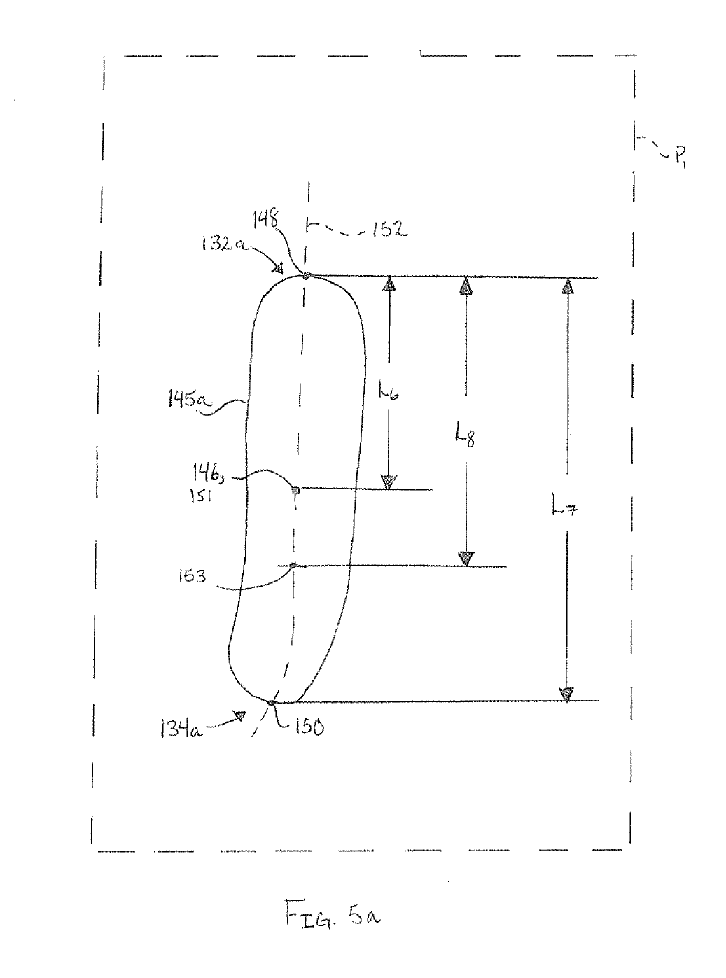

FIG. 5 is a top view of a portion of the strap system of FIG. 1 laid out in the plane of the paper.

FIG. 5(a) is a top view of the portion of the strap system of FIG. 5.

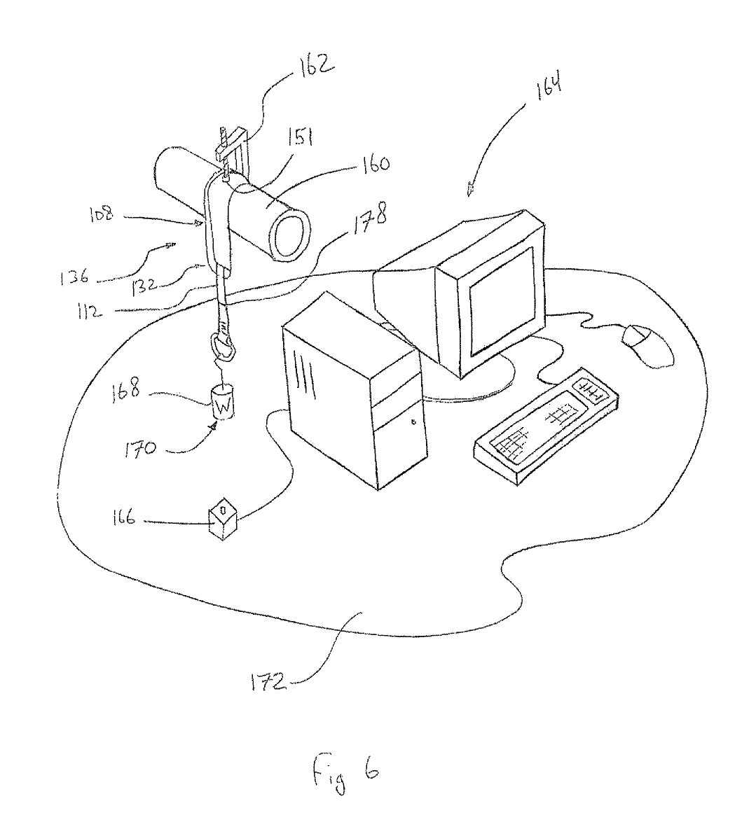

FIG. 6 is a perspective view of a configuration for measuring properties of the strap system of FIG. 1.

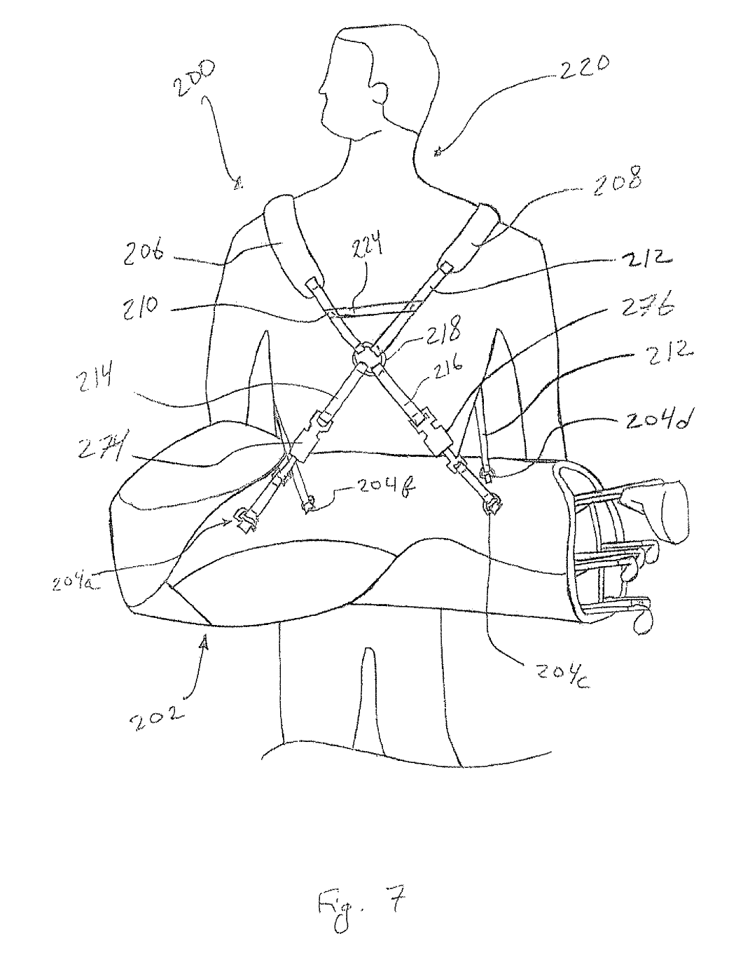

FIG. 7 is a rear perspective view of a strap system and golf bag in accordance with one or more aspects of the present invention.

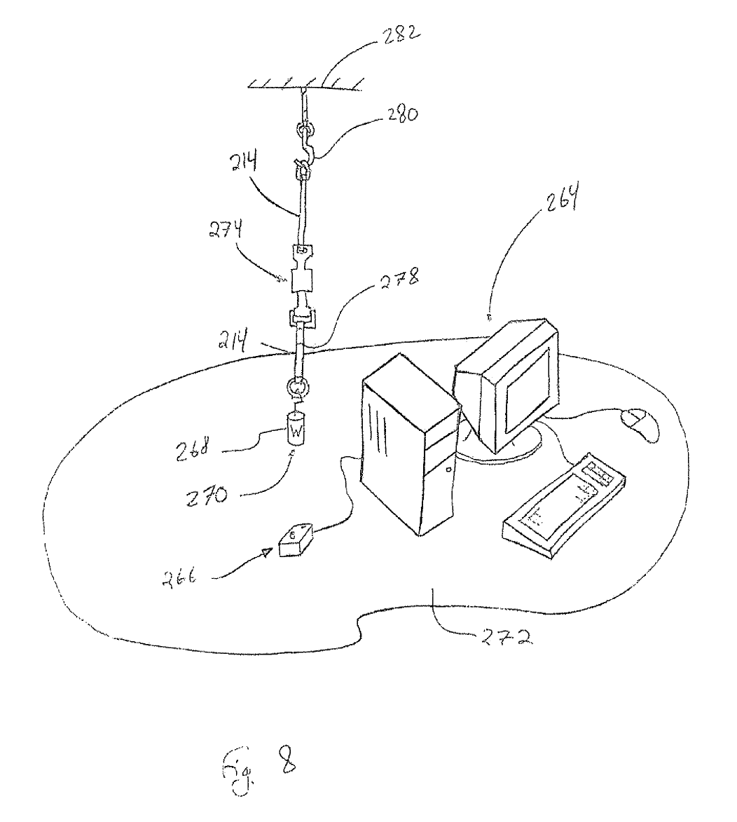

FIG. 8 is a perspective view of a configuration for measuring properties of the strap system of FIG. 7.

### DETAILED DESCRIPTION

Referring to FIG. 1, according to one or more aspects of the present invention, a golfer 120 is shown bearing the weight of a golf bag 102. The golf bag 102 is secured to the golfer's shoulders by a strap system 100. The strap system 100 includes support straps 110, 112, 114, and 116. A first shoulder pad 106 is integrated with the support strap 110. A second shoulder pad 108 is integrated with the support strap 112. The support strap 112 and shoulder pad 108 constitute a first strap sub-system 136. The support strap 110 and the shoulder pad 106 constitute a second strap sub-system 138. The golf bag 102 includes a tip end 184 and a butt end 186 opposite the tip end 184.

The support straps 110, 112, 114, and 116 are each coupled to a ring 118. Specifically, support strap 110 is coupled to the ring 118 by a stitching 110a. The support strap 112 is coupled to the ring 118 by stitching 112a. Similar stitchings may be presented to secure each of support straps 114 and 116 to the ring 118. Preferably, each of support straps 110, 112, 114, and 116 are slidably coupled to and, optionally, removable from, the ring 118. In this manner, the strap sub-systems 136 and 138 may self-adjust to fit comfortably on the shoulders of golfers having different body types. However, in one or more alternative aspects of the present invention, the support straps 110 and 112 are coupled to the ring 118 in fixed orientations. In one or more alternative aspects of the present invention, the support straps 110 and 112 are removably coupled to the ring 118, e.g. by associating each of the support straps 110 and 112 with brackets (e.g. Ladderloc Series brackets manufactured by Weisheng Plastic Industrial Co. of Taichung, Taiwan) or the like. In some aspects of the present invention, the ring 118 includes a D-ring, triangular-shaped ring, or diamond-shaped ring. Each or any of the support straps 110, 112, 114, and 116 may include a bracket (e.g. Ladderloc Series brackets manufactured by Weisheng Plastic Industrial Co. of Taichung, Taiwan) for enabling length adjustment to custom-fit the strap system 100 to a specific golfer.

As shown in FIGS. 1 and 1(a), the strap system 100 is secured to the golf bag 102 in four discrete, spaced apart, locations. Specifically, the support strap 114 is secured to the golf bag 102 by an attachment member 104a, the support strap 110 is secured to the golf bag 102 by attachment member 104b, the support strap 116 is secured to the golf bag 102 by an attachment member 104c, and the support strap 112 is attached to the golf bag 102 by attachment member 104d. The attachment members 104c and 104d are proximate the tip end 184 of the golf bag 102, while the attachment members 104a and 104b are distal the tip end 184 of the golf bag 102. Alternatively, the strap system 100 may be secured to the golf bag 102 at only two discrete locations. For example, the support straps 110 and 114 may be jointly secured to a single attachment member 104a and the support straps 112 and 116 may be jointly secured to the attachment member 104e. Alternatively, the strap system 100 may be secured to the golf bag 102 at three discrete locations. For example, the support straps 110 and 114 may be jointly secured to the attachment member 104a, the support strap 116 may be secured to the attachment member 104c, and the support strap 112 may be secured to the attachment member 104d.

Referring specifically to FIG. 1(a), the region of contact, between the attachment member 104a and the outer surface of the golf bag 102, and the region of contact, between the attachment member 104c and the outer surface of the golf bag 102, are spaced a minimum distance L₁ from each other. Preferably, L₁ is between about 5 inches and about 15 inches. More preferably, L₁ is between about 8 inches and 12 inches. Most preferably, L₁ is equal to about 10 inches. The regions of contact between each of the attachment members 104a and 104b and the outer surface of the golf bag 102 are spaced a minimum distance L₂ from each other. L₂ is preferably between about 0.5 inches and about 2.5 inches. More preferably, L₂ is between about 1.0 inch and 2.0 inches. Most preferably, L₂ is equal to about 1.5 inches. The regions of contact between each of the attachment member 104c and the attachment member 104c1 and the outer surface of the golf bag 102 are spaced a minimum distance L₃ from each other. Preferably, L₃ is between about 1.0 inches and about 3.5 inches. More preferably, L₃ is between about 1.75 inches and about 2.75 inches. Most preferably, L₃ is equal to about 2.25 inches.

Referring again to FIG. 1, the support straps 110, 112, 114, and 116 each comprise an inelastic material such as 600D nylon/diamond dobby, leather, or the like. A cross strap 124 is optionally coupled the support straps 110 and 112 by stitchings 124a and 124b, respectively. The cross strap 124 limits the ability of the shoulder pads 106 and 108 to separate and increases the efficiency with which the golfer 120 may place the strap system 100 onto his or her shoulders.

Referring to FIGS. 2 and 3, the strap sub-system 136 is shown in further detail. The shoulder pad 108 includes a forward end 134 and a rearward end 132 opposite the forward end 134. The forward direction, as used herein, denotes the direction, along the length of the shoulder pad 108 toward the front side of the golfer 120, when the strap system 100 is in an operating state. The rearward direction, as used herein, denotes the direction, along the length of the shoulder pad 108, toward the rear side of the golfer 120, when the strap system 100 is in an operating state. The support strap 112 enters the shoulder pad 108 through an opening 140 proximate the rearward end 132 and exits the shoulder pad 108 proximate the forward end 134. The support strap 112 is coupled to the shoulder pad 108 by a stitching 112d. In one or more aspects of the present invention, the support strap 112 is also stitched to the shoulder pad 108 at a location proximate the forward end 134 and, optionally, at locations between the stitching 112d and the forward end 134, along the length of the support strap 112 to further secure the support strap 112, to the shoulder pad 108.

As used herein, a “relaxed state” of a strap sub-system, e.g. the strap sub-system 136, denotes a state, or position, wherein the sub-system 136 or portions thereof is under no external tensile or compressive stress. As used herein, a fully-expanded position of a strap sub-system, e.g. strap sub-system 136, denotes a state, or position, wherein the sub-system 136 is fully-elongated, under stress, such that any further stressing would result in permanent deformation of, or damage to, the sub-system 136.

Referring to FIGS. 2 and 3, the support strap 112 is further coupled to an elastic member 126, between the rearward end 132 and the forward end 134 of the shoulder pad 108. Specifically, the support strap 112 is coupled to the elastic member 126 by at least two stitchings 112b that form therebetween at least one slack 112c when the elastic member 126 is in a relaxed state. Preferably, the support strap 112 is coupled to the elastic member 126 by at least three stitchings 112b, forming at least two slacks 112c therebetween, when the elastic member 126 is in a relaxed state. More preferably, the support strap 112 is coupled to the elastic member 126 by at least four stitchings 112b, forming at least three slacks 112c therebetween, when the elastic member is in a relaxed state. The elastic member 126 comprises a polymeric elastic material such as a synthetic rubber. In alternative aspects of the present invention, the elastic member 126 comprises natural rubber, a mechanical spring, a visco-elastic material, or the like.

Referring again to FIG. 3, the support strap 112 containing the elastic member 126 is sandwiched between the outer portion 142 and the inner portion 144 of the shoulder strap 108. In an operating state, the inner portion 144 is located proximate the shoulder of the golfer 120, and the outer portion 142 is located distal the shoulder of the golfer 120. The inner portion 144 includes a mesh external layer 108a, a durable internal layer 108e, and a resilient layer 108b therebetween. The resilient layer 108b preferably comprises a synthetic foam material for increasing comfort to the golfer 120. Alternatively, or in addition, the resilient layer 108b comprises a visco-elastic material and/or a material having shape-memory properties. The internal layer 108e comprises a durable material such as 500D nylon/diamond dobby. Preferably the internal layer 108c is sufficiently durable to withstand abrasion due to the cyclic movement of the support member 112 and/or cyclic expansion/contraction of the elastic member 126 during use. The outer portion 142 includes a durable internal layer 108c1, a mesh external layer 1081, and a resilient layer 108e therebetween. The durable internal layer 108d preferably includes a material such as 500D nylon/diamond dobby. Preferably the internal layer 108d is sufficiently durable to withstand abrasion due to the cyclic movement of the support member 112 during use. The resilient layer 108e preferably comprises a synthetic foam material for increasing comfort to the golfer 120. Alternatively, or in addition, the resilient layer 108e comprises a visco-elastic material and/or a material having shape-memory properties.

In use, the weight of the golf bag 102, including golf clubs and other equipment, imparts variable loading on the strap system 100 as the golfer 120 traverses a golf course. The variable loading results in variable tension on each of the support straps 110, 112, 114, and 116. A typical average overall load imparted on the strap system 100 is approximately 19 lbs. However, such average overall load necessarily depends on the number and weights of the various golf clubs carried by the golf bag 102 and the weight of any additional golf equipment and/or accessories carried by the golf bag 102. A typical average load on each support strap is 2 to 8 lbs, more specifically about 3 to 6 lbs. Also, given a predetermined golf bag and strap system configuration and given an average overall load, the typical average loads (or tensions) on each of support straps 110, 112, 114, and 116 may differ. For example, for a typical average overall load of 19 lbs, the support strap 116 may have a load, or tension, of 5.0 lbs, and the support strap 114 may have a load, or tension, of 3.3 lbs.

Referring again to FIGS. 2 and 3, when the strap sub-system 136 is secured to the shoulders of the golfer 120, and when a load, e.g. a golf bag carrying golf clubs and other golf equipment, is applied to the strap sub-system 136, a portion of the support strap 112 that is proximate the rear end 132 of the shoulder pad 108 freely slides relative to the shoulder pad 108, while a portion of the support strap 112 proximate the front end 134 of the shoulder pad 108 remains in fixed orientation relative to the shoulder pad 108. In addition, the resilient layers 108b and 108e are sufficiently resilient such that, in an operating position, the resilient layers 108b impart a compressive force onto the support strap 112 via the internal layers 108c and 108d. Accordingly, friction is generated between the support strap 112 and the shoulder pad 108. Such friction dampens vibration imparted on the strap system 100 from impulses that occur during typical variable loading, e.g. loading that occurs as a golfer traverses a golf course. The frictional force applied to the support strap 112, when the strap sub-system 136 is in an operating state, is further increased by the pressure applied to the shoulder pad 108 by the shoulder of the golfer 120. In one or more aspects of the present invention, the second strap sub-system 138, which includes support strap 110 and shoulder pad 106, has a configuration that is similar to the strap sub-system 136, discussed above.

Referring to FIGS. 4(a) and 4(b), a portion 136a of the first strap sub-assembly 136 is shown in further detail. In FIG. 4(a), the portion 136a, including the elastic member 126 and a portion of the support strap 112, is shown with the strap sub-system 136 in the relaxed position. In FIG. 4(b), the portion 136a, including the elastic member 126 and a portion of the support strap 112, is shown with the strap sub-system 136 in a fully-expanded position.

Referring to FIG. 4(a), the elastic member 126 is secured to the inelastic support strap 112 by stitchings 112b. Slacks 112c are formed in between each of the stitchings 112b. The slacks 112c enable the elastic member 126 to expand when an external tensile force is applied to the support strap 112. However, once the slacks 112c are fully elongated, i.e. fully extended in the longitudinal direction, as shown in FIG. 4(b), the elastic member 126 is constrained from further elongation. At this point, the portion 136a of the sub-system 136 is in the fully-expanded position. Preferably, the length L₄ of the elastic member 126, measured along the length of the expandable portion of the elastic member 126, when the elastic member 126 is in the relaxed state, is between about 1.0 inch and about 5.0 inches. More preferably, L₄ is between about 3.0 inches and about 4.0 inches. Most preferably, L₄ is equal to about 3.5 inches. Preferably, the length L₅ of the elastic member 126, measured along the length of the expandable portion of the elastic member 126, when the elastic member 126 is in the fully-expanded state, is between about 5.0 inches and about 10 inches. More preferably, L₅ is between about 6.5 inches and about 8.5 inches. Most preferably, L₅ is equal to about 7.25 inches. Further, in one or more aspects of the present invention, L₄ and L₅ are related in that a ratio L₄/L₅ is between about 0.25 and about 0.75. More preferably, L₄/L₅ is between about 0.40 and about 0.60. Most preferably, L₄/L₅ is equal to about 0.50. In one or more aspects of the present invention, the strap sub-system 138 has a configuration that is similar to the strap sub-system 136, discussed above.

Referring to FIG. 5, the strap sub-system 138 is laid out in a horizontal plane P₁, which corresponds to the plane of the paper. The support strap 112 extends rearward from the rear end 132 of the shoulder pad 106 and extends forward from the forward end 134 of the shoulder pad 106. The support strap 112 follows a generally linear path proximate the rear end 132 of the shoulder pad 106. The support strap 112 follows a generally arcuate path proximate the forward end 134 of the shoulder pad 106. An imaginary support strap center line 152 extends in a longitudinal direction of the support strap 112, midway across the width W of the support strap 112 and midway across the thickness T of the support strap 112.

As shown in FIG. 5, strap sub-system 136 is in the fully expanded position such that the support strap center line 152 is substantially horizontal and, thus, substantially co-planar with the horizontal plane P₁. A perimetric boundary 145, characterized as the nexus of points forming the outer most boundary of the shoulder pad 106, as viewed in a direction normal to the plane P₁, is projected onto the plane P₁ to form a perimetric boundary projection line 145a, as shown in FIG. 5a.

The perimetric boundary projection line 145a may include a forward end 134a and a rearward end 132a. The strap center line 152 intersects the perimetric boundary projection line 145a at the forward end 134a and the rearward end 132a. The point of intersection between the strap center line 152 and the forward end 134a designates a forwardmost point 150. The point of intersection between the strap center line 152 and the rearward end 132a designates a rearwardmost point 148.

Referring again to FIG. 5a, the forwardmost point 150 and the rearwardmost point 148 are spaced from each other by a length L₇. An imaginary line 146 is perpendicular to the plane P₁, intersects the strap center line 152, and is spaced from the rearwardmost point 148 by a horizontal distance L₆, which is equivalent to 0.36*L₇. The imaginary line 146 intersects the upper surface 149 of the shoulder pad 106 at a locating point 151. Preferably, L₇ is between about 15 inches and about 30 inches. More preferably, L₇ is between about 18 inches and 25 inches. Most preferably, L₇ is equal to about 21 inches.

As discussed above, stitchings 112b are applied to the support strap 112 and the elastic member 126 for creating slacks 112c (see FIG. 4(a)). Such stitchings 112b also define a rearwardmost extent 156 and a forwardmost extent 158 of the expandable portion of the elastic member 126, along the center line 152 (see FIG. 5). The forwardmost extent 158 may be projected onto the plane P₁ and may intersect the center line 152 at a point 153 (see FIG. 5a). The point 153 is spaced a horizontal distance L₈ from the rearwardmost point 148. Preferably, L₈ is between about 5.0 inches and about 10.0 inches. More preferably, L₈ is between about 7.0 inches and 9.0 inches. Most preferably, L₈ is equal to about 8.5 inches. Preferably, lengths L₇ and L₈ are related in that a ratio L₈/L₇ is no greater than about 0.60, more preferably, between about 0.25 and about 0.50, even more preferably between about 0.35 and about 0.45, and most preferably equal to about 0.40. Inter alia, the location of the elastic member 126 along the center line 152 affects the frictional force applied to the elastic member 126 and, in turn, affects the degree of damping. This is due to the fact that as the elastic portion 126 location nears the imaginary line 146, belt friction resulting from the curvature of the golfer's shoulder becomes increasingly significant. Thus, different preferences are within the scope of the invention, particularly if different typical average load values than those discussed above are anticipated to act on the strap system 100.

In one or more aspects of the present invention, the support strap 110 is configured similarly to the support strap 112, as discussed above. However, as discussed above, each of support straps 110 and 112 may experience different tensions based in part on the geometric configuration of the strap system 100 and of the mass distribution of the golf bag 102 to which the strap system 100 is secured. Thus, in alternative aspects of the present invention, aspects of the location of the elastic member 126, e.g. the distance L₈, differs from corresponding aspects of the location of the corresponding elastic member of the support strap 112.

Referring to FIG. 6, in one or more aspects of the present invention, the strap sub-system 136 includes a spring constant, k₁, and a damping ratio, Z₁, selected to maximize comfort given the typical variable loading applied to the strap sub-system 136. These properties are to be determined based on the following arrangement:

The strap sub-system 136 is suspended from a rigid tube 160 having a smooth exterior surface and an outer diameter of 4.50 inches (for simulating the contour of a golfer's shoulder). The tube 160 may comprise, e.g., a polymeric material such as polyvinyl chloride (PVC). The strap sub-system 136 is clamped to the tube 160 at the locating point 151 of the shoulder pad 108 and oriented such that the direction of elongation of the shoulder pad 108 generally lies in the circumferential direction of the tube 160. The rearward end 132 of the shoulder pad 108 hangs over the front end of the tube 160.

A mark 178 is placed on an inelastic portion of the strap sub-system 112 and a weight 168 of 5.0 lbs is suspended from a portion of the inelastic support strap 112. The central axis of the weight 168 is aligned vertically (relative to the ground 172) with a proximity sensor 166, which is capable of detecting the distance the sensor is from a bottom surface 170 of the weight 168. The proximity sensor 166 communicates with a computing device 164 for transmitting time-dependent location data of the bottom surface 170 of the weight 168.

To find k₁, a first height h₁ of the mark 178, relative to the ground 172, is measured without the weight 168 secured to the support strap 112. Next, the weight 168 is secured to the support strap 112 of the strap sub-system 136. Once the strap sub-system 136 reaches an equilibrium (or static) position, a second height h₂ of the mark 178 is measured, relative to the ground 172. The value k₁ is determined as follows:

k₁=(5.0 lbs)/(h₁−h₂)

To find the damping ratio Z₁ of the strap sub-system 136, a downward impulse is applied to the weight 168, causing the strap sub-system 136 to oscillate until an equilibrium, or static, position is reached. Immediately following the impulse, the time-dependent location of the bottom surface 170 of the weight (relative to the sensor 166) is detected at periodic intervals by the proximity sensor 166 and recorded. Based on the weight 168 of 5.0 lbs, the spring constant k₁ calculation above, and the time-dependent location data, the damping ratio Z₁ may be calculated using conventional empirical, mathematical, or computational methods.

For determining the spring constant k₂ and the damping ratio Z₂ of the strap sub-system 138, the strap sub-system 138 is secured to the tube 160 in like manner to that of the strap sub-system 136. However, a weight (not shown) of 3.0 lbs is used in place of the weight 168 of the 5.0 lbs, and the properties k₂ and Z₂ are calculated accordingly.

Preferably, k₁ and k₂ are each between about 5.0 lbs/in and about 25.0 lbs/in, more preferably between about 8 lbs/in and about 24 lbs/in, and most preferably between about 12 lbs/in and about 18 lbs/in. In some aspects of the present invention, k₁ is greater than k₂ to accommodate a greater typical average load. In these cases, the absolute different between k₁ and k₂ is greater than or equal to about 5 lbs/in, more preferably between about 10 lbs/in and about 20 lbs/in. The spring constants k₁ and k₂ of the strap sub-systems 136 and 138 may be increased by increasing the thickness or width of elastic members, or selecting, for the elastic members, materials having higher stiffness. In some aspects of the present invention, the elastic portion 126 of the strap sub-system 136 is thicker than the corresponding elastic portion of the strap sub-system 138. Alternatively or in addition, the elastic portion 126 of the sub-system 136 is of a different, and stiffer, material than the corresponding elastic portion 127 of the sub-system 136.

Preferably, Z₁ and Z₂ are each between about 0.4 and about 1.6, more preferably between about 0.8 and about 1.2, and most preferably equal to about 1.0. Such ranges ensure that the comfort of the strap system 100 is maximized as the golfer 120 traverses a golf course. Additionally, preferably, Z₁ and Z₂ are substantially equal. However, because each strap sub-system 136 and 138 is under different tension, a damping coefficient, c₁ and c₂, respectively, of sub-systems 136 and 138 preferably varies. The damping coefficient, c₁, of strap sub-system 136 may be increased by nearing the location of the elastic member 126 to the imaginary line 146 (FIG. 5). Alternatively, or in addition, the damping coefficient, c₁, of strap sub-system 136 may be increased by increasing the friction force imparted on the elastic portions 126 and/or respective support strap 112, e.g. by providing resilient layers 108b and/or 108e (FIG. 3) that further inhibit translational motion of each the support strap 112. Thus, in some aspects of the present invention, the thickness and/or material properties of each or either of resilient members 108b and 108e (FIG. 3) differ from those of the corresponding resilient layers of shoulder pad 106 (not shown). Preferably, the resilient layers 108b and 108e (FIG. 3) are adapted to impart a greater frictional force on the support strap 112 and/or elastic member 126 than the frictional force imparted by the like resilient layers of the shoulder pad 106 on the support strap 110 and/or the elastic member 127. Thus, in some aspects of the present invention, the location of the elastic member 126 is nearer to the imaginary line 146 than the corresponding elastic member of the strap sub-system 138 is to the corresponding imaginary line of the strap sub-system 138.

Referring to FIG. 7, in one or more aspects of the present invention, a strap system 200 is secured to a golf bag 202. In an operating state, as shown, the golf bag 202 holds golf clubs and related golf equipment, and the strap system 200 is secured to the shoulders of a golfer 220. The strap system 200 includes support straps 210, 212, 214, and 216. Each of the support straps 210, 212, 214, and 216 are relatively inelastic. Shoulder pads 206 and 208 are integrated with support straps 210 and 212, respectively. A ring 218 is coupled to each of the support straps 210, 212, 214, and 216.

The golf bag 202 includes attachment members 204a, 204b, 204c, and 204d for attaching each of the support straps 214, 210, 216, and 212 to the golf bag 202. Specifically, the support strap 210 is secured, optionally slidably and/or removably, to the ring 218 and the attachment member 204b. The support strap 214 is secured, optionally slidably and/or removably, to the ring 218 and the attachment member 204a. The support strap 212 is secured, optionally slidably and/or removably, to the ring 218 and the attachment member 204d. The support strap 216 is secured, optionally slidably and/or removably, to the ring 218 and the attachment member 204c. The attachment members 204a, 204b, 204c, and 204d are spaced from each other similarly to the manner discussed above with regard to the attachment members 104a, 104b, 104c, and 104d of the aspect of the present invention shown in FIG. 1. In alternative aspects of the present invention, the strap system 200 includes only three attachment members, or alternatively only two attachment members, secured to the golf bag 202 in a similar manner as discussed with regard to the aspect of the present invention shown in FIG. 1.

A shock absorbing means 274 is integrated with the support strap 214, and a shock absorbing means 276 is integrated with the support strap 216. Alternatively, or in addition, a shock absorbing means is integrated with support strap 210, support strap 212, and/or with the ring 218. Specifically, in some aspects of the present invention, the shock absorbing means is located between the shoulder pad 206 and the ring 218, the shoulder pad 208 and the ring 218, the shoulder pad 206 and the attachment portion 204b, and/or the shoulder pad 208 and the attachment member 204d.

In any of the aspects of the present invention discussed above with reference to FIG. 7, the shock absorbing means includes a device configured to substantially deform elastically (i.e. undergo greater than 5% elongation or contraction) under average tensile or compressional forces applied during typical use of the golf bag 202 (i.e. tensile forces and/or compressive forces of between about 3 lbs to about 8 lbs). Preferably, the shock absorbing means also includes a device configured to damp vibrations (i.e. dissipate energy) associated with typical use. In one or more aspects of the present invention, the shock absorbing means comprises, either alone or in combination, a conventional spring and dashpot type shock absorber, a visco-elastic material, such as a silicone, having elastic and/or viscous properties, a pneumatic spring and damping device, a hydraulic spring and damping device, and an electronic device configured to generate tensile resistance, or the like. The shock absorbing means may be configured to elastically deform and/or provide damping in either tension or compression. In some aspects of the present invention, discrete elastically-deforming features and/or vibration damping features of the shock absorbing means may be configured in series. In alternative aspects of the present invention, discrete elastically-deforming features and/or vibration damping features of the shock absorbing means may be configured in parallel.

Preferably, the support strap 214/shock absorbing means 274 combination, and/or the support strap 216/shock absorbing means 276 combination, has a spring constant, k₃ and/or k₄, respectively, of between about 5.0 lbs/in and about 25.0 lbs/in, more preferably between about 8 lbs/in and about 24 lbs/in, and most preferably between about 12 lbs/in and about 18 lbs/in. In some aspects of the present invention, k₃ differs from k₄ to account for different loads on each support strap 214 and 216 due to the configuration and mass distribution of the golf bag 202 and golf clubs and equipments carried by the golf bag 202. Preferably k₄ is greater than k₃. More preferably, a difference between k₃ and k₄ is greater than or equal to about 5.0 lbs/in, more preferably between about 10 lbs/in and about 20 lbs/in.

Further, preferably, the support strap 214/shock absorbing means 274 combination, and/or the support strap 216/shock absorbing means 276 combination has a damping ratio, Z₃ and/or Z₄, respectively, of between about 0.4 and 1.6, more preferably between about 0.8 and about 1.2, and most preferably equal to about 1.0. Where a similar shock absorbing means is integrated with support strap 210 and/or 212, similar ranges of spring constant and damping ratio are preferable.

Referring to FIG. 8, these properties are to be determined as follows. The support strap 214 is suspended from a rigid hook 280 secured to a rigid surface 282. Because the shock absorbing means 274 and 276 are not integrated with either of the shoulder pads 206 and 208, no rigid tube (e.g. rigid tube 160 of FIG. 6) is required to simulate a shoulder of the golfer 220.

A mark 278 is placed on a portion of the inelastic support strap 214, and a weight 268 of 5.0 lbs is suspended from a portion of the inelastic support strap 214. The weight 268 is aligned vertically (relative to the ground 272) with a proximity sensor 266 capable of detecting the position of a bottom surface 270 of the weight 268. The proximity sensor 266 communicates with a computing device 264 for transmitting time-dependent location data of the bottom surface 270 of the weight 268.

To find k₃, a first height h₃ of the mark 278, relative to the ground 272, is measured without the weight 268 secured to the support strap 214. Next, the weight 268 is secured to the support strap 214. Once the support strap 214 reaches an equilibrium (or static) position, a second height h₄ of the mark 278 is measured, relative to the ground 272. The value k₃ is determined as follows:

k₃=(5.0 lbs)/(h₃−h₄)

To find the damping ratio Z₃ of the support strap 214/shock absorbing means 274 combination, a downward impulse is applied to the weight 268, causing the support strap 214 to oscillate until an equilibrium, or static, position is reached. Immediately following the impulse, the time-dependent location of the bottom surface 270 of the weight is detected by the proximity sensor 266 and recorded. Based on the weight 268 of 5.0 lbs, the spring constant k₃ calculation above, and the time-dependent location data, the damping ratio Z₃ may be calculated using conventional empirical, mathematical, or computational methods.

The spring constant k₄ and the damping coefficient Z₄ are to be determined using the same method, but substituting the support strap 216/shock absorbing means 276 combination for the support strap 214/shock absorbing means 274 combination. Further, to determine spring constant and/or damping ratio of combinations of shock absorbing means with either of support straps 210 and 212, a similar method is to be used.

In some aspects of the present invention, at least one of shock absorbing means 274 and 276 are removably secured to support straps 214 and/or support strap 216. In some aspects of the present invention, one, or both, of shock absorbing means 274 and 276 further includes an adjustment device (not shown) for enabling a user to adjust the degree of stiffness and/or degree of damping of either or both of the shock absorbing means 274 or 276.

While various features have been described in conjunction with the examples outlined above, various alternatives, modifications, variations, and/or improvements of those features and/or examples may be possible. Accordingly, the examples, as set forth above, are intended to be only illustrative. Various changes may be made without departing from the broad spirit and scope of the underlying principles.

What is claimed is:

1. A shock-absorbing strap assembly for attachment to a load comprising:
an inelastic strap having an elongate direction and a widthwise direction;
a discrete elastic member having a expandable portion, the elastic member coupled to the inelastic strap, wherein the inelastic strap is coupled to, and overlaps, the elastic member such that, when the strap assembly is in a relaxed state, the inelastic strap forms at least one slack; and
a shoulder pad coupled to the inelastic strap and at least partially overlapping the inelastic strap and the elastic member, such that at least a portion of the inelastic strap slidably engages with at least a portion of the shoulder pad when an external tension is applied to the inelastic strap.

2. The strap assembly of claim 1, wherein, in the relaxed state, the inelastic strap further comprises at least two slacks that are each separated by a stitching.

3. The strap assembly of claim 1, wherein, in the relaxed state, the inelastic strap further comprises at least three slacks that are each separated by a stitching.

4. The strap assembly of claim 1, wherein:
when the strap assembly is in the relaxed state, the expandable portion of the elastic member has a first length measured in the elongate direction;
when the strap assembly is in a fully-expanded state, the expandable portion of the elastic member has a second length measured in the elongate direction, and
a ratio of the first length to the second length is between about 0.25 and about 0.75.

5. The strap assembly of claim 4, wherein the ratio of the first length to the second length is between about 0.40 and about 0.60.

6. The strap assembly of claim 1, further comprising a spring constant between 5 lb/in and about 25 lb/in.

7. The strap assembly of claim 1, further comprising a damping ratio between about 0.40 and about 1.60.

8. The strap assembly of claim 7, wherein the damping ratio is between about 0.8 and about 1.2.

9. The strap assembly of claim 1, wherein the strap assembly is securable to the golf bag at no less than three discrete locations.

10. A shock-absorbing strap assembly for attachment to a load comprising:
a first sub-assembly including:
a first inelastic strap having a first elongate direction and a first widthwise direction;
a first discrete elastic member having a first expandable portion, the first elastic member coupled to the first inelastic strap, wherein the first inelastic strap is coupled to, and overlaps, the first elastic member such that, when the strap assembly is in a relaxed state, the first inelastic strap forms one or more first slacks; and
a first shoulder pad coupled to the first inelastic strap and at least partially overlapping the first inelastic strap and the first elastic member, such that at least a portion of the first inelastic strap slidably engages with at least a portion of the first shoulder pad when an external tension is applied to the first inelastic strap; and
a second sub-assembly including:
a second inelastic strap having a second elongate direction and a second widthwise direction;
a second discrete elastic member having a second expandable portion, the second elastic member coupled to the second inelastic strap, wherein the second inelastic strap is coupled to, and overlaps, the second elastic member such that, when the strap assembly is in a relaxed state, the second inelastic strap forms one or more second slacks; and
a second shoulder pad coupled to the second inelastic strap and at least partially overlapping the second inelastic strap and the second elastic member, such that at least a portion of the second inelastic strap slidably engages with at least a portion of the second shoulder pad when an external tension is applied to the second inelastic strap.

11. The strap assembly of claim 10, wherein the first sub-assembly further comprises a first spring constant and the second sub-assembly further comprises a second spring constant that is different than the second spring constant.

12. An apparatus for transporting golf clubs comprising a golf bag and the strap assembly of claim 10.

13. The apparatus of claim 12, wherein the golf bag comprises no less than three discrete attachment members and the strap assembly comprises no less than three discrete inelastic straps, each secured to one of the attachment members.

14. The apparatus of claim 13, wherein the golf bag comprises no less than four discrete attachment members and the strap assembly comprises no less than four discrete inelastic straps, each secured to one of the attachment members.

15. The apparatus of claim 12, wherein:
the golf bag comprises a tip end and a butt end opposite the tip end;
the first sub-assembly further comprises a first spring constant, and the second sub-assembly further comprises a second spring constant;
the first inelastic strap is coupled to the golf bag proximate the tip end of the golf bag;
the second inelastic strap is coupled to the golf bag distal the tip end of the golf bag; and
the first spring constant is greater than the second spring constant.

16. A strap assembly for attachment to a load comprising:
a first discrete sub-assembly and a second discrete sub-assembly, each of the first and second sub-assemblies comprising:
an inelastic strap having a first, a second end, an intermediate portion located between, and spaced from each of, the first end and the second end, and extending in an elongate direction;
an elastic member coupled to the intermediate portion of the inelastic member and extending in the elongate direction of the inelastic strap; and
a first resilient member and a second resilient member, wherein the intermediate portion of the inelastic strap and the elastic member are sandwiched between, and in slidable contact with, the first resilient member and the second resilient member.

17. The strap assembly of claim 16, wherein the first resilient member and the second resilient member are adapted to exert a compressive force on the elastic member and the intermediate portion of the inelastic strap.

18. The strap assembly of claim 16, wherein the first sub-assembly further comprises a first spring constant between about 5.0 lbs/in and about 20 lbs/in and the second sub-assembly further comprises a second spring constant between about 15 lbs/in and about 30 lbs/in.

19. The strap assembly of claim 18, wherein the first spring constant is different from the second spring constant.

20. The strap assembly of claim 16, wherein the first sub-assembly further comprises a first damping ratio between about 0.4 and about 1.6, and the second sub-assembly further comprises a second damping ratio between about 0.4 and about 1.6.

21. A strap assembly for attachment to a shoulder of a golfer for carrying a golf bag, the strap assembly comprising:
an inelastic strap member having a width, a thickness, a first end, a second end opposite the first end, an intermediate portion between, and spaced from each of, the first end and the second end, and an imaginary center line located midway between the width and the thickness, the inelastic strap extending in an elongate direction;
an elastic member coupled to the intermediate portion of the inelastic strap, the elastic member having an expandable portion including a first end and a second end rearward of the first end, in the elongate direction;
a shoulder pad comprising a resilient material, a forward end, and a rearward end, the shoulder pad overlapping, and in slidable contact with, at least the intermediate portion of inelastic strap;
wherein, when the strap assembly is laid out in a horizontal plane such that the center line of the support strap is generally parallel to the horizontal plane,
a nexus of points defining the outer most boundary of the shoulder pad, as viewed in a direction normal to the horizontal plane, projected on the horizontal plane, forms a projected perimetric boundary of the shoulder pad;
the perimetric boundary intersects the center line at a forward end and at a rearward end opposite the forward end;
a first length extends between the forwardmost end of the expandable portion of the elastic member, projected in the horizontal plane, and the rearward end of the perimetric boundary of the shoulder pad; and
a second length extends between the forward end and the rearward end of the perimetric boundary of the shoulder pad such that a ratio of the first length to the second length is between about 0.25 and about 0.50.
